(19) United States
(12) Patent Application Publication
(10) Pub. No.: US 2019/0089301 A1
(43) Pub. Date: Mar. 21, 2019

(54) SYSTEM AND METHOD FOR SOLAR CELL DEFECT DETECTION

(71) Applicant: X Development LLC, Mountain Veiw, CA (US)

(72) Inventor: Roberto Collins, San Jose, CA (US)

(73) Assignee: X Development LLC, Mountain View, CA (US)

(21) Appl. No.: 15/707,392

(22) Filed: Sep. 18, 2017

(51) Int. Cl. H02S 50/15

(52) U.S. Cl. CPC H02S 50/15

(57) ABSTRACT

A system for testing a solar panel includes an electrical power supply, an imaging device, and a computing device. The electrical power supply is configured to couple to a solar panel and supply an electrical current at least one cell of the solar panel, thereby inducing electroluminescence in the at least one cell. The imaging device is configured to measure the electroluminescence of the at least one cell. The computing device is coupled to the imaging device, the computing device configured to determine a defect in the at least one cell based on a measurement of the electroluminescence of the at least one cell.

### TECHNICAL FIELD

The present disclosure relates to systems and methods for inspecting solar panels. More specifically, the present disclosure relates to systems that induce electroluminescence in solar panels and detect defects in one or more solar cells on a solar panel based on an analysis of the light emitted by the solar panel while electroluminescence is induced.

### BACKGROUND

Manufacturing of solar panels may result in defects in one or more solar cells of the solar panels. Some solar cell defects have a minimal effect on the efficacy of the solar panel during the lifetime of the panel, while other defects cause immediate reduction in functionality and possibly failure of the solar panel. Solar cells may be damaged through physical contact with foreign objects, flexing of the solar cell, or application of other mechanical pressures or forces. Damage may be in the form of scratches or cracks, which reduce the efficacy of the solar panel either immediately or over time.

Visual inspections of the solar cells in a solar panel have been used to detect cells, and by extension panels. These visual inspections are often targeted at identifying which solar cells are at an increased risk of a reduction in functionality or failure based on identifiable defects in the solar cells of the solar panel. Such visual inspection often requires an individual who is inspecting the panels to have experience in identifying cells which have failed or are likely to fail. Accordingly, there is a need for systems and methods of detecting defective solar cells and solar panels without relying on visual inspection of the solar cells or solar panels.

### SUMMARY

According to one aspect, the present disclosure relates to a system for testing solar panels including a plurality of cells. The system includes an electrical power supply, an imaging device, and a computing device. The electrical power supply is configured to couple to a solar panel and supply an electrical current to at least one cell of the solar panel. The supplied electrical current induces electroluminescence in the at least one cell. The imaging device is configured to measure the electroluminescence of the at least one cell. The computing device is coupled to the imaging device and configured to determine a defect in the at least one cell based on a measurement of the electroluminescence of the at least one cell.

In some embodiments, the electrical power supply may further be configured to supply the electrical current at a first current level and a second current level different form the first current level.

In certain embodiments, the imaging device may be further configured to measure a first intensity of the electroluminescence in the at least one cell at the first current level and a second intensity of the electroluminescence in the at least one cell at a second current level.

In some embodiments, the computing device is further configured to calculate an intensity ratio between the first intensity and the second intensity.

In certain embodiments, the computing device is further configured to compare the intensity ratio to a ratio threshold to determine whether the at least one cell is defective.

In some embodiments, the imaging device is further configured to capture an image of the electroluminescence of the at least one cell.

In certain embodiments, the computing device is further configured to isolate each of the cells into a constituent image.

In some embodiments, the computing device may be further configured to analyze the constituent image to identify a physical defect in the at least one cell based on a difference in darkness of a portion of the constituent image.

According to embodiments, the computing device may further be configured to determine at least one of size or shape of the physical defect.

In some embodiments, the computing device may be further configured to determine at least one of a size or a shape of the physical defect by generating two lines contacting an image of the physical defect and measuring an angle formed by the two lines.

According to another aspect of the present disclosure, a method for testing a solar panel including at least one cell includes supplying an electrical current to at least one cell of the solar panel thereby inducing electroluminescence in the at least one cell, measuring the electroluminescence of the at least one cell, and determining a defect in the at least one cell based on the measurement of the electroluminescence of the at least one cell.

In some embodiments, measuring the electroluminescence includes capturing an image of the solar panel.

According to embodiments, measuring the electroluminescence includes capturing an image of a plurality of cells of the solar panel.

In some embodiments, the method for testing the solar panel further includes isolating the cells of the solar panel in the image into a constituent image.

In some embodiments, the method may further include determining the electroluminescence of a plurality of regions of a target cell, and determining at least one region includes the defect. The target cell may be one of the isolated cells.

According to embodiments, determining at least one region of the target cell includes the defect may further include determining the defect is a crack.

In certain embodiments, the method may further include comparing an average electroluminescence of the target cell with an average electroluminescence of the isolated cells in response to determining the at least one region of the target cell includes the defect, and determining the target cell is shunted based on comparison of the average electroluminescence of the target cell with the average electroluminescence of the isolated cells.

In embodiments, the method may further include determining the target cell is non-operational based on determining the defect is a crack and the target cell is shunted.

### BRIEF DESCRIPTION OF THE DRAWINGS

Embodiments of the present disclosure are described herein with reference to the accompanying drawings, wherein:

FIG. 1 illustrates a solar panel testing system according to embodiments of the present disclosure;

FIG. 2 is a functional block diagram of a computing device for controlling the solar panel testing system of FIG. 1;

FIG. 3 is a graphical user interface (GUI) for providing inputs to the solar panel testing system of FIG. 1;

FIG. 4A is a flow chart illustrating a method of applying an electric current to a solar panel to induce electroluminescence according to an embodiment of the present disclosure;

FIG. 4B is a flow chart illustrating a method of identifying defective solar panels according to an embodiment of the present disclosure;

FIG. 5 is a flow chart illustrating a method of identifying shunted solar panel cells according to an embodiment of the present disclosure;

FIG. 6 is a flow chart illustrating a method of identifying operationally defective solar panel cells according to an embodiment of the present disclosure;

FIG. 7 is an illustration of a solar panel where electroluminescence is induced with a first current, according to embodiments of the present disclosure;

FIG. 8A is an illustration of the cracked solar cell of the solar panel of FIG. 7 when electroluminescence is induced in the solar cell;

FIG. 8B is an illustration of the scratched solar cell of the solar panel of FIG. 7 when electroluminescence is induced in the solar cell;

FIG. 8C is an illustration of the cracked and shunted solar cell of FIG. 7 when electroluminescence is induced in the solar cell; and

FIGS. 9A-9B is an illustration of an embodiment of the method of identifying cracked solar cells of the solar panel of FIG. 6;

FIGS. 10A-10B is an illustration of an embodiment of the method of identifying cracked and shunted solar cells of FIG. 6; and

FIGS. 11A-11B is an illustration of yet another embodiment of the method of identifying scratched solar panel cells of FIG. 6.

### DETAILED DESCRIPTION

The accompanying drawings, which are incorporated in and constitute a part of the specification, illustrate embodiments of the disclosure and, together with a general description of the disclosure given above, and the detailed description of the embodiment(s) given below, serve to explain the principles of the disclosure. As such, embodiments of the present disclosure are described in detail with reference to the drawings, in which like reference numerals designate identical or corresponding elements in each of the several views.

As used herein, the term “solar panel” refers to a panel which includes one or more solar cells for capturing and absorbing photons to be converted into electrical energy. The term “solar cell” refers to photovoltaic devices which convert photons into electrical energy, such as direct current (DC) energy, and form constituent components of the solar panel. The term “electroluminescence” refers to emission of light from one or more solar cells in response to an electric current being applied thereto. Light emitted as a result of inducing electroluminescence is referred to as a luminescence or intensity value.

As used herein, the term “region” refers to an area on a solar panel or solar cell. When referring to regions with respect to image data, each value stored in the image data corresponds to a region on the solar panel. The regions may be “merged” or combined to define larger regions located on the solar panel or cell.

A system and method for testing solar panels according to the present disclosure is configured to detect defective solar cells. The system includes a power supply that is coupled to one or more solar cells of the solar panel, such that an electric current is transmitted from the power supply to the solar panel, thereby inducing electroluminescence in the solar cells. An imaging device captures electroluminescence in the form of two-dimensional images or intensity measurements, and transmits sensor data corresponding to the captured electroluminescence to a computing device. The computing device analyzes the sensor data and determines whether one or more solar cells in the solar panel are failing or defective.

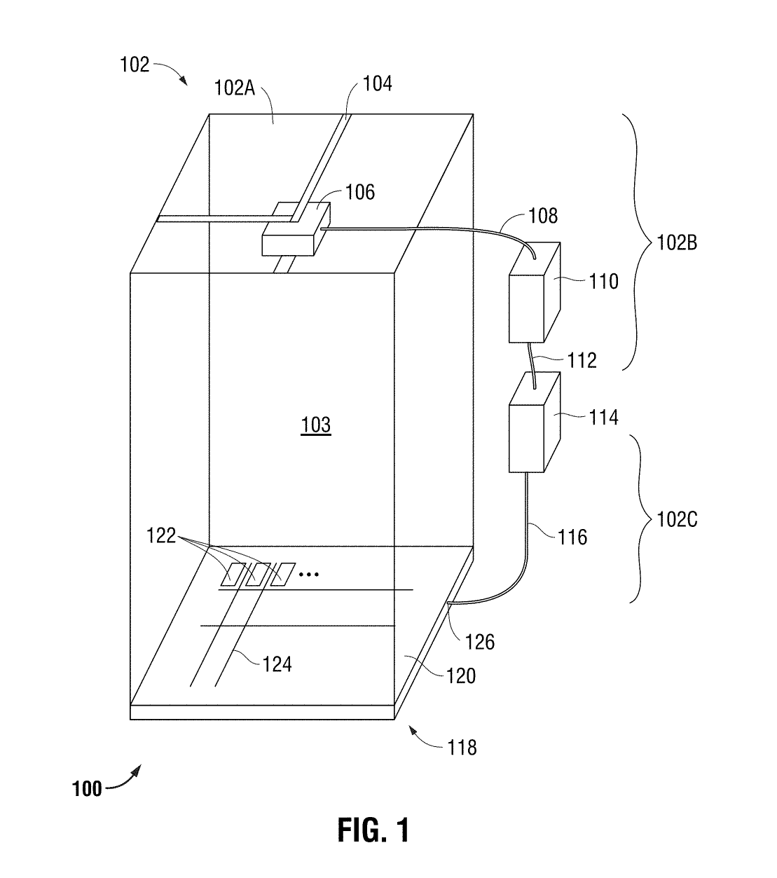

Referring initially to FIG. 1, there is shown an embodiment of a solar panel testing system 100 (hereinafter “testing system 100”) which includes a housing 102 having a plurality of sides 102A which, when assembled, define a cavity 103. In embodiments, the sides 102A of the housing may be coated in a non-reflective material, e.g., dark fabrics, dark flat paints, etc., which minimize reflection of light received by the sides 102A. The testing system 100 includes an electric power supply 114 coupled to the solar panel 118 via a wired connection 116. The power supply 114 is configured to supply an electric current to the solar panel 118 to induce electroluminescence in one or more solar cells 122 of the solar panel 118. The power supply 114 may vary a current level of the electric current, e.g., “C₁”-“Cₙ” to induce electroluminescence in one or more of the solar cells 122 of the solar panel 118. In embodiments, the power supply 114 transmits power at a first current level “C₁” and a second current level “C₂” to one or more of the solar cells 122 of the solar panel 118.

The housing 102 of the testing system 100 defines a first portion 102B and a second portion 102C. The housing 102 further includes one or more supports 104 configured to couple to an imaging device 106. The imaging device 106 couples to the supports 104 along the first portion 102B of the cavity 103, the supports 104 maintaining the position of the imaging device 106 relative to the housing 102. The imaging device 106 may include a near-infrared sensor (NIRS) (not shown), which is configured to capture images of a solar panel 118 disposed within the second portion 102C of the housing 102. Specifically, the imaging device 106 is configured to capture near-infrared images (NIRS) of the solar panel 118 as electroluminescence is induced in response to the application of the electric current “C” from the power supply 114. The imaging device 106 may include any suitable sensor capable of capturing images of a solar panel 118 as electroluminescence is induced in one or more of the solar cells 122.

The solar panel 118 is located within the second portion 102C of the housing 102 with one or more solar cells 122 facing the first portion 102B of the housing 102. Specifically, the solar panel 118 includes a surface 120 which faces the imaging sensor 106 when positioned within the first portion 102B of the housing 102. The surface 120 has one or more solar cells 122 positioned in an array thereon. The solar panel 118 further includes a connection port 126 for receiving the wired connection 116. When the current “C” is transmitted by the power supply 114 to the solar panel 118 and is received at the connection port 126, the current “C” is transferred to one or more solar cells 122 of the solar panel 118, thereby inducing electroluminescence in the solar cells 122. As electroluminescence is induced in the one or more solar cells 122, the resulting light which is transmitted by the solar cells 122 is transmitted toward the first portion 102B of the housing 102, and received by the imaging sensor 106. As arranged on the solar panel 118, the solar cells 122 form an array, which extend along the surface 120 of the solar panel 118 and are divided by grid lines 124.

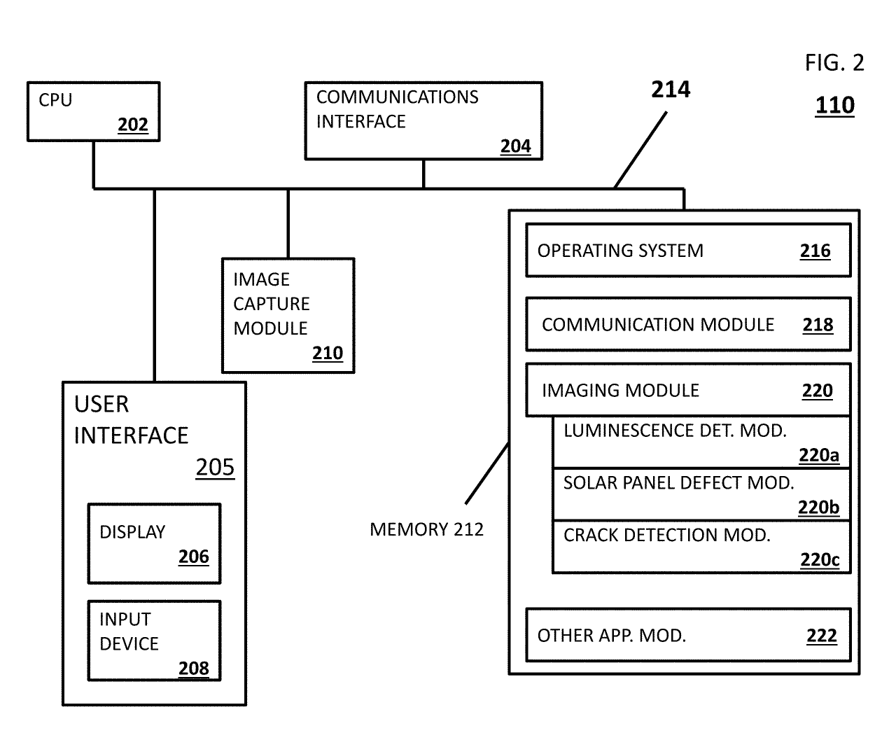

The imaging device 106 is coupled to a computing device 110 via a connection 108. In embodiments, it is contemplated that the imaging device 106 may transmit wireless signals to the computing device 110 via wireless connection, e.g., WI-FI®, BLUETOOTH®, LTE ®, and other known wireless communication configurations or protocols. The wired connection 108 supports communication between the imaging device 106 and a processing unit 202 (FIG. 2) associated with the computing device 110. Specifically, the connection 108 transmits input signals to the computing device 110, the input signals including sensor signals or sensor data generated by the imaging device 106. Additionally, the connection 108 may transmit control signals from the computing device 110 to the imaging device 106 to cause the near-infrared image sensor to capture images of the solar panel 118.

The computing device 110, is further coupled to the power supply 114 via a wired connection 112 to receive electricity from the power supply 114. Additionally, the computing device 110 sends control signals to the power supply 114, thereby controlling the transmission of an electric current “C” from the power supply 114 to the solar panel 118. In embodiments, it is contemplated that the computing device 110 may be in wireless communication with the power supply 114 to transmit control signals thereto and to receive input signals therefrom. A detailed description of the computing device 110 is included below with reference to FIG. 2.

Referring to FIG. 2, there is illustrated a block diagram of the computing device 110 in accordance with an embodiment of the present disclosure. The computing device includes a processing unit 202, a communications interface 204, a memory 212, and communications buses 214 to transfer signals therebetween. The computing device 110 further includes a user interface 205 which includes a display 206, and an input device 208. The input device 208 may be a keyboard, mouse, microphone, or similar device. The display 206 may be any display, including a touch display, for displaying an image or series of images generated by the processing unit 202.

With continued reference to FIG. 2, the computing device 110 further includes an image capture module 210 for receiving input signals from the image capture device 106. As illustrated, the image capture module 210 is coupled to the imaging device 106 via wired connection 108 (FIG. 1) to receive input signals from the imaging device. The image capture module 210 is in communication with the memory 212 for transferring input signals to be stored in the memory 212. In embodiments, the image capture module 210 may further include an antenna (not shown) to enable wireless communication with the imaging device 106, or alternatively may be configured to receive input signals from a communication interface 204. The image capture module 210 may further include memory (not shown) such as flash memory for storage of input signals received from the imaging device prior to transmission to the memory 212.

The memory 212 includes random-access memory (RAM), such as DRAM, SRAM, DDR RAM, or other random access solid state memory devices. The memory 212 may further include non-volatile memory, such as magnetic disk storage devices, optical disk storage device, flash memory, or other non-volatile solid state storage devices. In embodiments, the memory 212 includes memory, such as volatile or non-volatile memory, located remotely from the processing unit 202.

In some embodiments, the memory 212 is configured to store programs, modules, and data structures, or subsets thereof for execution by the processing unit 202 to cause the processing unit to perform one or more tasks. Specifically, but not exclusively, the memory 212 includes programs, modules, and data structures as defined herein: an operating system 216, a communications module 218, an imaging module 220, and one or more other or additional application modules or optional applications 222.

The operating system 216 includes instructions which, when executed by the processing unit 202, allocate basic system resources and perform hardware dependent tasks such as allocating memory portions of the memory 212 for the storage of information such as instructions, data, etc. The communications module 218 includes instructions which, when executed by the processing unit 202, establish connections between the computing device 110 and external devices, e.g., without limitation, the imaging device 106, the power supply 114, remote storage devices, and remote computing devices. The image capture module 220 includes instructions which, when executed by the processing unit 202, cause the processing unit 202 to transmit control signals to the image capture module 210. Upon reception of the control signals, the imaging device 106 captures one or more images of the solar panel 118 and transmits the captured images as sensor data or images to the image capture module 210. The image capture module 210 transfers the images to an imaging module 220 for analysis.

The imaging module 220 includes one or more sub-modules which include, without limitation, a luminescence detection module 220a for identifying shunted or short circuited solar cells 122 (FIG. 1) based on a measured luminescence of the solar cell 122; a solar panel defect detection module 220b for identifying solar panels 118 which may be defective, operational, or operationally defective, e.g., the solar panel 118 has one or more cracked solar cells 122 which are not shunted; and a crack detection module 220c for identifying cracked solar cells 122 based on luminescence variations within the solar cell 122.

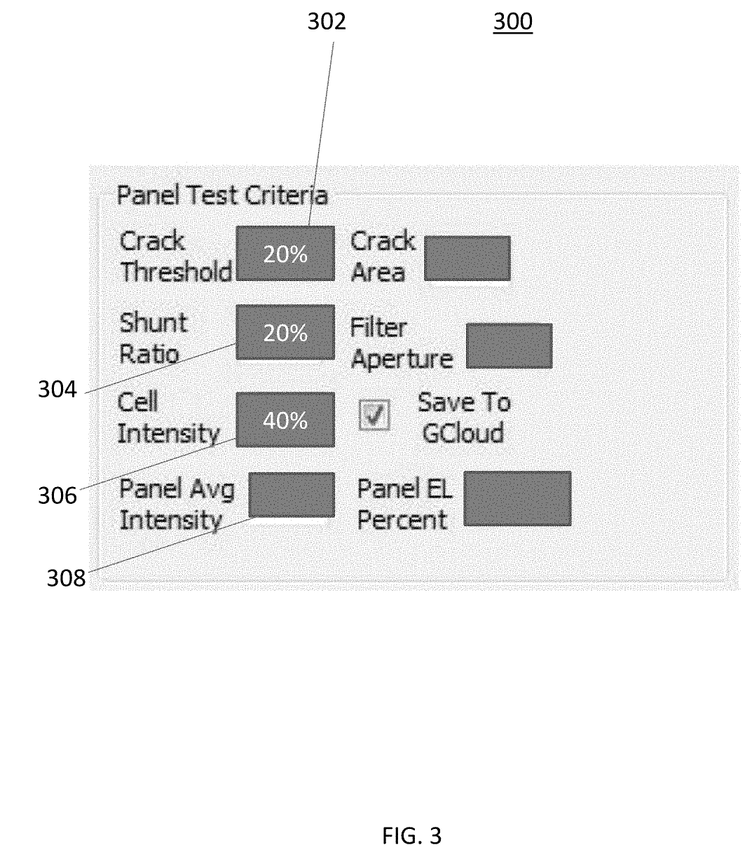

Referring to FIG. 3, there is illustrated a graphical user interface (GUI) 300 including fields for accepting criteria values for identifying solar panels 118 which are defective. The fields include a crack threshold field 302, a shunt ratio field 304, a cell intensity field 706, and a panel average intensity field 308.

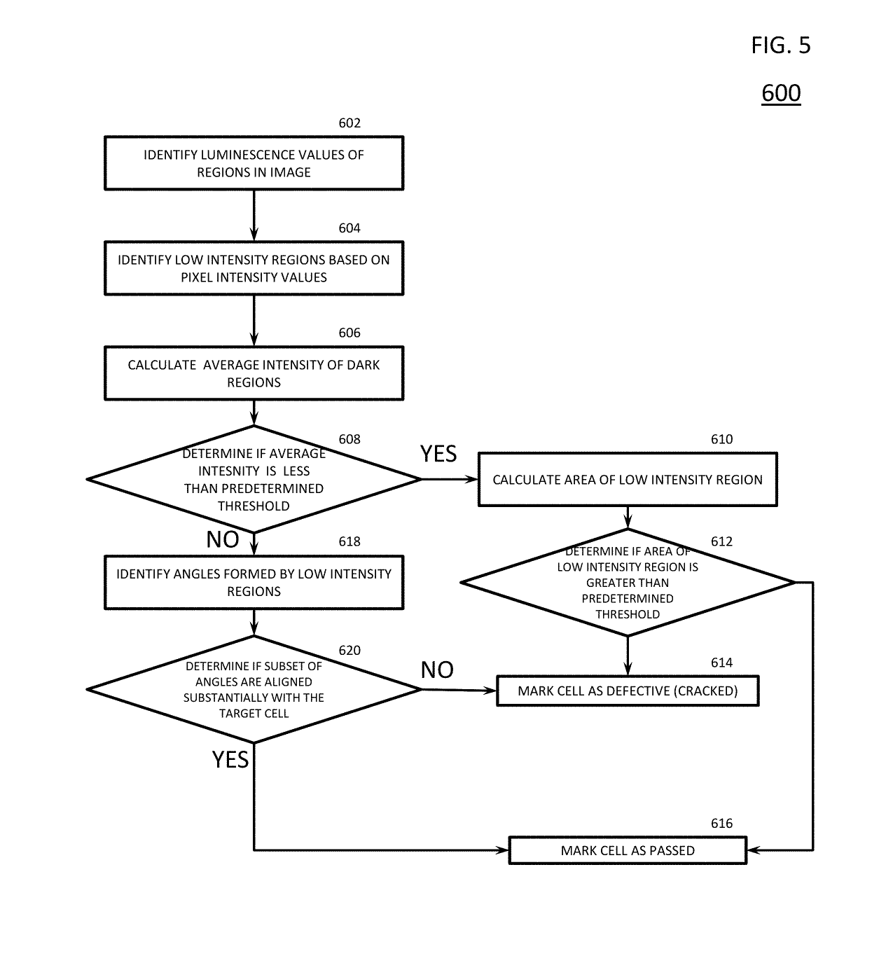

The crack threshold filed 302 of the GUI 300 corresponds to an intensity deviation value or intensity ratio used by the testing system 100 to identify dark regions “R_{dark}” in a solar cell 122. (see FIG. 5). More particularly, the value input in the crack threshold field 302 defines an acceptable amount or percentage by which intensity values of adjacent regions located along the solar cell 122 may deviate without being indicative of an edge of a crack along a solar cell 122. When the deviation of the intensity values of a first and second region in a solar cell 122 are less than the value input in the crack threshold field, the first and second region are not identified as indicative of an edge of a dark regions “R_{dark}”. Alternatively, when the deviation is between the first region and the second region is greater than the value input in the crack threshold field, a dark region “R_{dark}” is identified in the solar cell, the dark region “R_{dark}” including the region (either the first or the second region) with the lower measured intensity value. For example, without being limited to a specific unit of measurement, if the intensity of the first region (e.g., a first pixel) is 10 units and the value of the second region (e.g., a second pixel adjacent to the first pixel) is 5 units, and the value input in the crack threshold field is 20%, the first region and second region have a deviation of 50% which indicates one of the two regions is located in at least part of a dark region “R_{dark}” in the solar cell 122. More particularly, the second region (with the lower intensity measurement) is identified as being located in at least part of a dark region “R_{dark}” of the solar cell 122. Alternatively, if the intensity measurement of the first and second region are 10 and 9, respectively, the first and second region have a deviation of 10% which indicates that the first and second region do not define an edge of a dark region “R_{dark}” along the solar cell 122.

The shunt ratio field 304 of the GUI 300 corresponds to an intensity deviation value or intensity ratio used by the testing system 100 to identify shunted solar cells 122. More particularly, the value input in the shunt ratio field 304 defines an acceptable amount or percent by which the average luminescence value of a solar cell 122 may deviate by when a first and second current are applied to the solar cells 122 to induce electroluminescence. When the deviation in the measured luminescence of the solar cell 122 is greater than the value input in the shunt ratio field 304 as first and second currents are applied, the solar cell 122 is identified as shunted. Alternatively, when the deviation is less than the value input in the shunt ratio field, the solar cell 122 is identified as not-shunted or operational.

The cell intensity field 306 of the GUI 300 corresponds to a deviation between an average intensity of a target solar cell 122a and an average intensity of all solar cells 122 of a solar panel 118 when electroluminescence is induced. The average intensity of the solar panel 118 is determined by averaging the intensity of the target solar cell 122a and the remaining solar cells 122 on the solar panel 118 to determine an average panel intensity. When the average intensity of the target solar cell 122a is compared to the average panel intensity of the solar panel 118, the deviation is compared to the value input in the cell intensity field 306 to determine whether the target solar cell 122a is shunted as compared to the solar panel 118 generally. More particularly, when the deviation between the intensity of the target solar cell 122a relative to the solar panel 118 is less than the value input in the cell intensity field 306, the target solar cell 122a is identified as shunted.

The panel average intensity field 308 of the GUI 300 corresponds to a threshold average panel intensity value. When a first current “C₁” is applied to a solar panel 118 to induce electroluminescence, an average luminescence value of the solar panel 118 is calculated. The average luminescence value is then compared to the value input in the panel average intensity field which corresponds to an acceptable luminescence value when the first current “C₁” is applied. In embodiments, the value input in the panel average intensity field 308 corresponds to a predetermined average intensity of an operational solar panel 118 when the first current “C₁” is applied.

The criteria values described with respect to the crack threshold field 302, the shunt ratio field 304, and the cell intensity field 306 may be predetermined and stored in the memory 212 of the computing device 110. Additionally, the criteria values may be user-supplied as input received by the computing device 110.

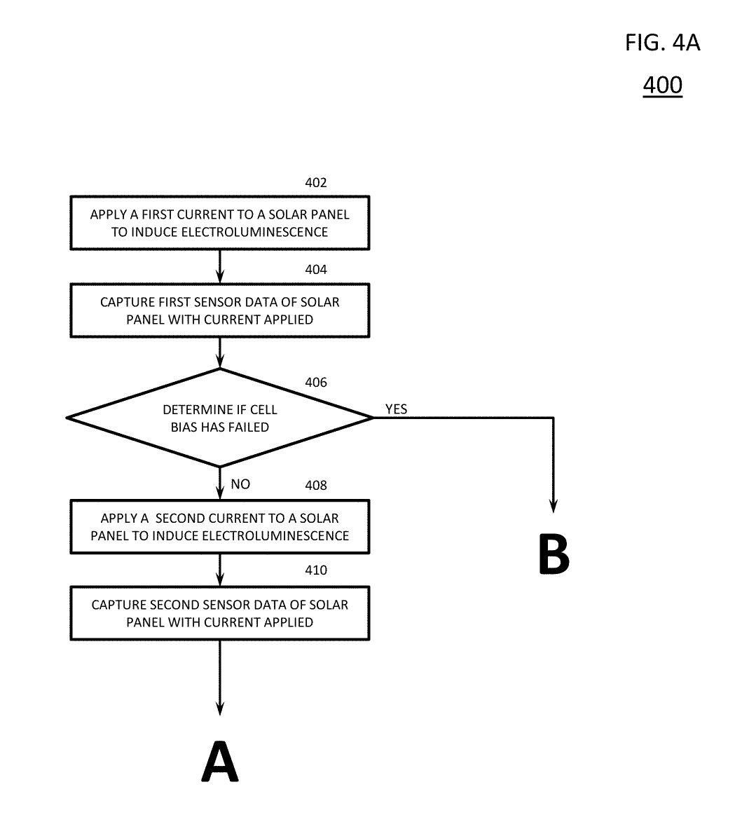

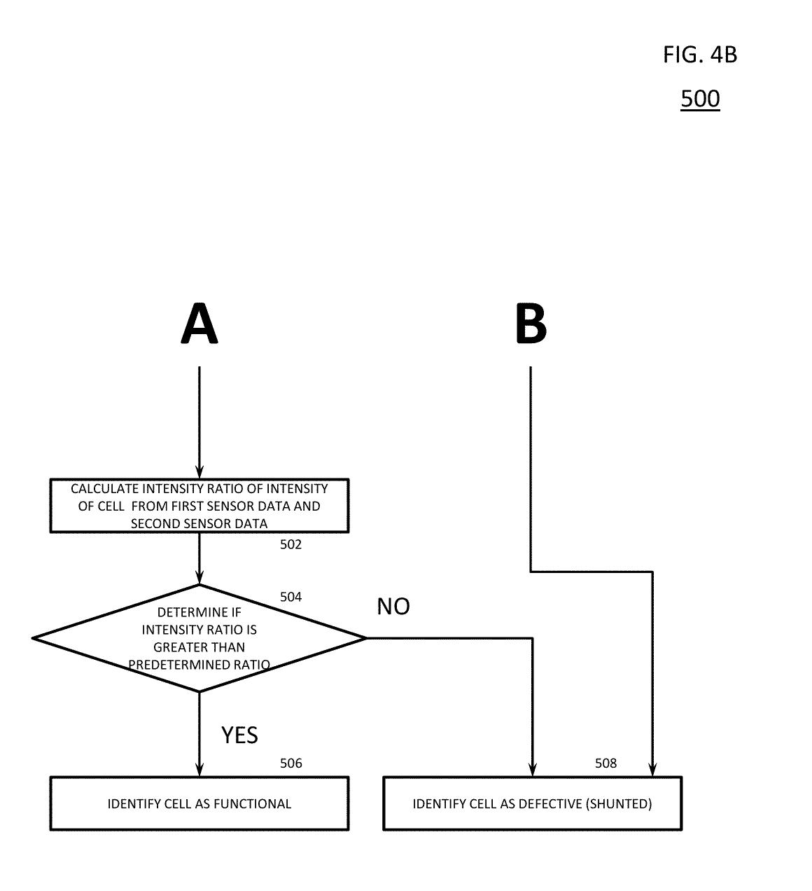

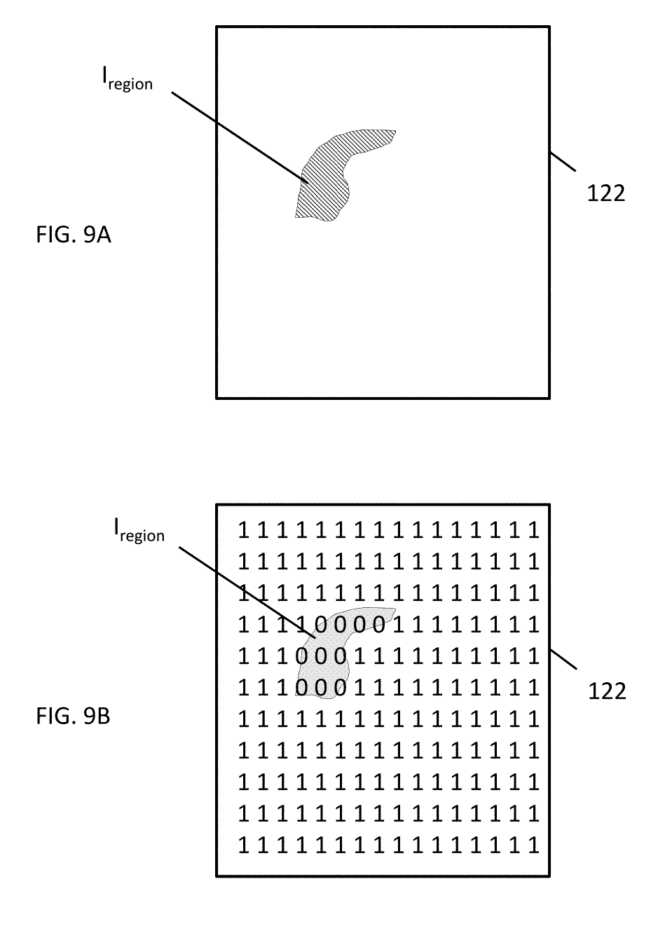

Referring to FIG. 4A, a method 300 for inducing electroluminescence in one or more solar cells 122 in a solar panel 118 to capture near-infrared images of the solar cell 122 is shown. Initially, a first current “C₁” is applied to one or more solar cells 122 of the solar panel 118 (402). As the first current “C₁” is received by the solar cells 122, the solar cells 122 emit near-infrared light which is captured by the image sensor 106 (404). The near-infrared light is stored as a two-dimensional (2D) image (see FIGS. 9B, 10B, 11B) in flash memory (not shown) of the imaging device 106. The image includes a plurality of pixels having an intensity value corresponding to a region of the solar cell 122, the luminescence values representative of the intensity of light emitted by the region of the solar cell 122 when electroluminescence is induced. For example, without reference to any specific unit of measurement, as illustrated in FIG. 9B intensity values between 0 and 1 are assigned to regions of the captured image. Regions with a value of 1 are regions of higher intensity, and regions with a value of 0 are regions of lower intensity. This process of applying an electric current “C” (402) to induce the emission of near-infrared light is commonly referred to as “biasing” the solar cell 122.

With continued reference to FIG. 4A, the captured image, and more specifically a first average intensity value “avg(I₁)” of all or regions in the image, is compared to a first control value “avg(I_{control})” associated with the first current “C₁” (406). In embodiments, the first average intensity value “avg(I₁)” may correspond to a subset of pixels of the image captured by the imaging device 106, the subset of pixels selected by the user or by default by the computing device 110 as predetermined regions. The first average intensity value “avg(I₁)” may be calculated by adding the intensity values of each region of a solar cell 122, and dividing the value by area covered by the region. The first control value “avg(I_{control}” is defined as an expected average intensity value associated with the application of the first current “C₁” to the solar cell 122. The first control value “avg(I_{control}” may be stored in the memory 212 of the computing device 110 or may be set by a user operating the solar panel testing system 100 via the input device 208 (see FIG. 3). When it is determined that the first average intensity value “avg(I₁)” is less than the first control value “avg(I_{control})” the biasing of the solar cell 122 is deemed to have failed or be otherwise non-operational (406).

Non-operational solar cells 122 may be underperforming solar cells 122, such as shunted solar cells 122. Additionally, non-operational solar cells 122 may be solar cells 122 which have completely failed due to cracks, shunting, manufacturing defects, age, or other events which cause the solar cell 122 not to be capable of producing near-infrared light when biased.

When the biasing of the solar cell 122 is determined to be successful (406) the method of inducing electroluminescence 400 continues and a second current “C₂” is applied to the one or more solar cells 122 being analyzed (408). The second current “C₂” may be any current different from the first current “C₁”. For purposes of clarity, the second current “C₂” is defined herein as a current level less than the first current “C₁”. As the second current “C₂” is applied to one or more solar cells 122 of the solar panel 118 (408) the imaging device 106 captures a second image of the solar panel 118 (410).

Referring to FIG. 4B, a method 500 for determining whether a solar cell 122 is shunted includes capturing a first and second image of the solar cell 122 by the imaging device 106 as a first current “C₁” and a second current “C₂” are applied to a solar panel 118 to bias one or more solar cells 122 (402-S410) (FIG. 4A).

The intensity values of each region in each solar cell 122 are then averaged while electroluminescence is induced at the first current level “C₁” and the second current level “C₂”, the averages identified as a first average intensity value “avg(I₁)” and a second average intensity value “avg(I₂)”, respectively. The second average luminescence value “avg(I₂)” is then subtracted from the first average luminescence value “avg(I₁)” (where “avg(I₂)” is less than “avg(I₁)”) to determine an intensity difference. The value of the second current “C₂” is likewise subtracted from the value of the first current “C₁”to calculate a current difference. The intensity difference is then divided by the current level difference to determine an intensity ratio I_{R} for the solar cell 122 at the first current level and the second current level (502).

$${I}_{R} = \frac{avg ( {I}_{1} ) - avg ( {I}_{2} )}{{C}_{1} - {C}_{2}}$$

After the intensity ratio “I_{R}” is calculated, a determination is made as to whether the intensity ratio “I_{R}” is greater than a predetermined intensity ratio threshold (504). Where the luminescence ratio “I_{R}” is less than the predetermined luminescence ratio threshold, the solar cell 122 is identified as functional (506). Alternatively, where the luminescence ratio “I_{R}” is greater than the predetermined luminescence ratio threshold, the solar cell 122 is identified as shunted or defective (508).

With reference to FIG. 5, a method 600 for identifying cracks or dark regions “R_{dark}” in a solar cell 122 initially identifies the intensity value of each region in a target solar cell 122a (602). Where the intensity value of a pixel is less than an intensity threshold value “I_{threshold}” the pixel is identified as a dark pixel. The intensity threshold value “I_{threshold}” is defined as a threshold intensity value that separates two ranges of intensity values. In embodiments, the intensity threshold value “I_{threshold}” is associated with the first current “C₁” at which electroluminescence is induced and defines the threshold between dark regions “R_{dark}” and normal regions along the target solar cell 122a. In additional embodiments, the intensity threshold value “I_{threshold}” may be a ratio between the intensity value of an individual region relative to an average of the intensity values of the region defining the solar cell 122 entirely. Where one or more dark pixels are located adjacent to one another, a “R_{dark}” region identified, the dark region “R_{dark}” or associating the adjacent dark pixels (604) (see FIGS. 9B, 10B, 11B). The average intensity of the dark region “avg(R_{dark})” is then determined by averaging the intensity value of each region included in the identified dark region “R_{dark}” (606). When the average intensity value of the dark region “avg(R_{dark})” is less than a dark region intensity threshold “Dark_{threshold}” (FIG. 4) (608), the area of the dark region “R_{dark}” is determined by calculating the area of each region within the dark region “R_{dark}” (610). The dark region intensity threshold “Dark_{threshold}” is defined as a predetermined intensity value which differentiates between dark regions “R_{dark}” and normal or non-dark regions. In embodiments, the dark region intensity threshold “Dark_{threshold}” may be the average intensity value of the collective regions of the surrounding solar cells 122.

Where the area of the dark region “R_{dark}” is greater than a predetermined area threshold, the target solar cell 614 is identified as defective, particularly as having a crack in the region enclosed by the dark region “R_{dark}” (614). Where a cell has more than one dark region “R_{dark}”, the areas of each dark region “R_{dark}” are combined to determine whether the area of the resulting dark region “R_{dark}” is greater than the predetermined area threshold (612). Where it is determined that the overall area encompassed by one or more dark regions “R_{dark}” is less than the predetermined area threshold (612), the target solar cell 122a is identified as operational.

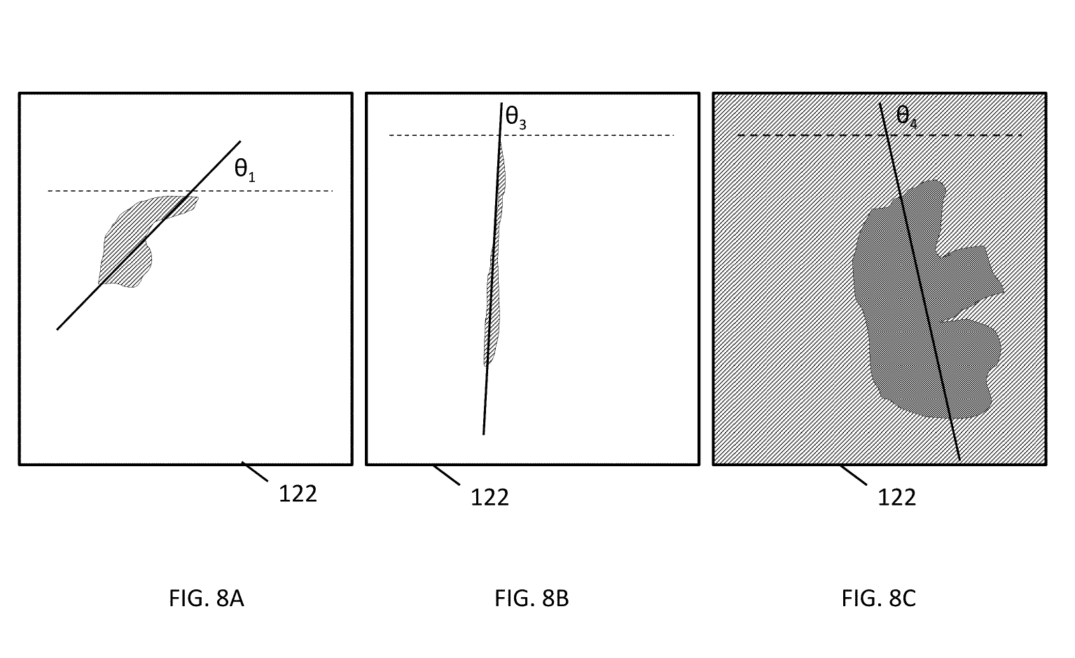

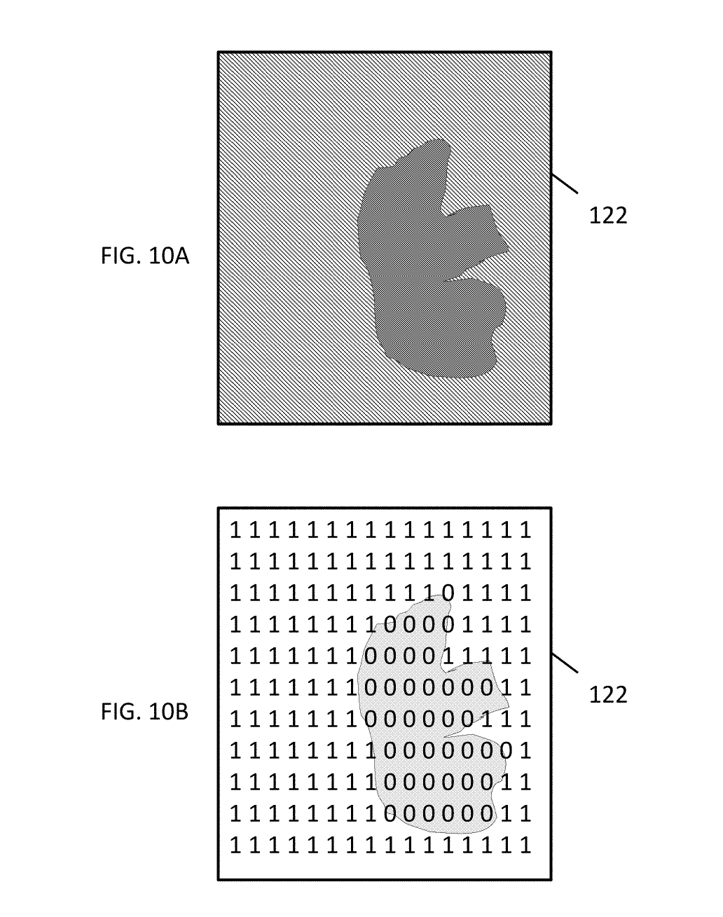

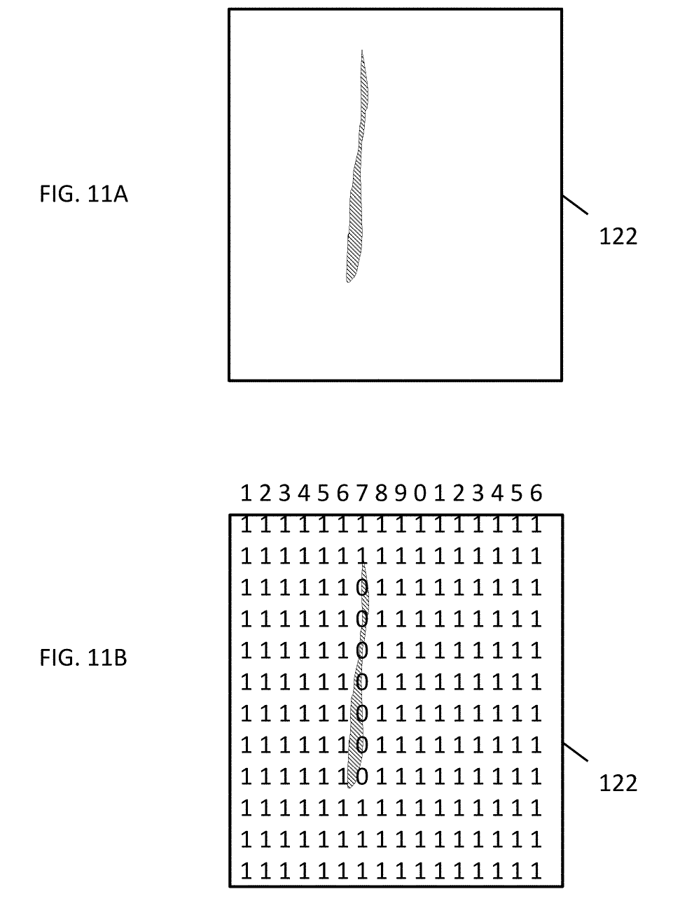

Alternatively, when the average intensity of the identified dark regions “avg(R_{dark})” is greater than the dark region intensity threshold “Dark_{threshold}”, the orientation of the dark region “R_{dark}” is analyzed to determine whether the dark region “R_{dark}” is either a manufacturing scratch or a crack. A manufacturing scratch is defined as a dark region “R_{dark}” which extends along the target solar cell 122a in substantially parallel relation to conductive strips located along the target solar cell 122a. An example of a manufacturing scratch is shown in FIGS. 8A and 8B, with the scratch traversing the solar cell 122 vertically in the same direction as the conductive strips (not shown) of the solar cell 122. Alternatively, a crack may be a dark region “R_{dark}” which is not substantially parallel to the conductive strips located along the target solar cell 122a (see FIGS. 9A and 10A). A dark region “R_{dark}” is substantially parallel to the conductive strips when the dark region “R_{dark}” is located in a threshold subset of columns which are aligned with the conductive strips (see FIG. 11A). In embodiments, a dark region “R_{dark}” is substantially parallel to the conductive strips when a line fit to the dark region “R_{dark}” forms an angle “θ” with a horizontal line which is between approximately 80 and 110 degrees (+/− about 10 degrees from 90 degrees) (see FIG. 11A).

Where the dark regions “R_{dark}” are oriented substantially parallel to the conductive strips located on the target cell 122a (620), the dark regions are identified as manufacturing scratches and the target solar cell 122a is identified as operational (616). Alternatively, where the dark regions “R_{dark}” are not oriented substantially parallel to the conductive strips located on the target cell 122a (620), the dark regions “R_{dark}” are identified as defects, specifically as scratches (614).

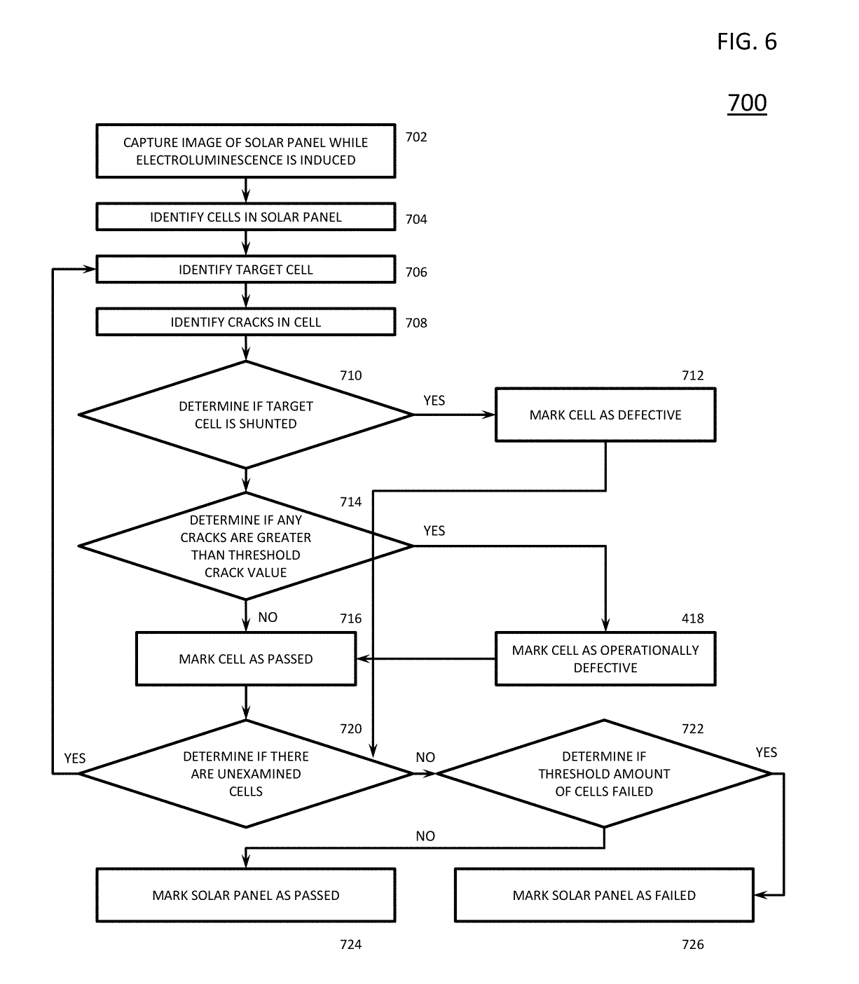

With reference to FIG. 6, a method 700 for detecting one or more defective solar cells 122 in the solar panel 118 is shown. Initially, electroluminescence is induced in a solar panel 118 by applying an electric current to one or more solar cells 122 as described above with respect to steps 402 and 404 of the method 400 of FIG. 4A. As electroluminescence is induced in the solar cells 122, the solar panel 118 emits near-infrared light. The near-infrared light is then captured by the imaging device 106 as sensor data, more particularly as an image. The image is transmitted as an input signal to the computing device 110 and stored in the memory 212 of the computing device 110 (702).

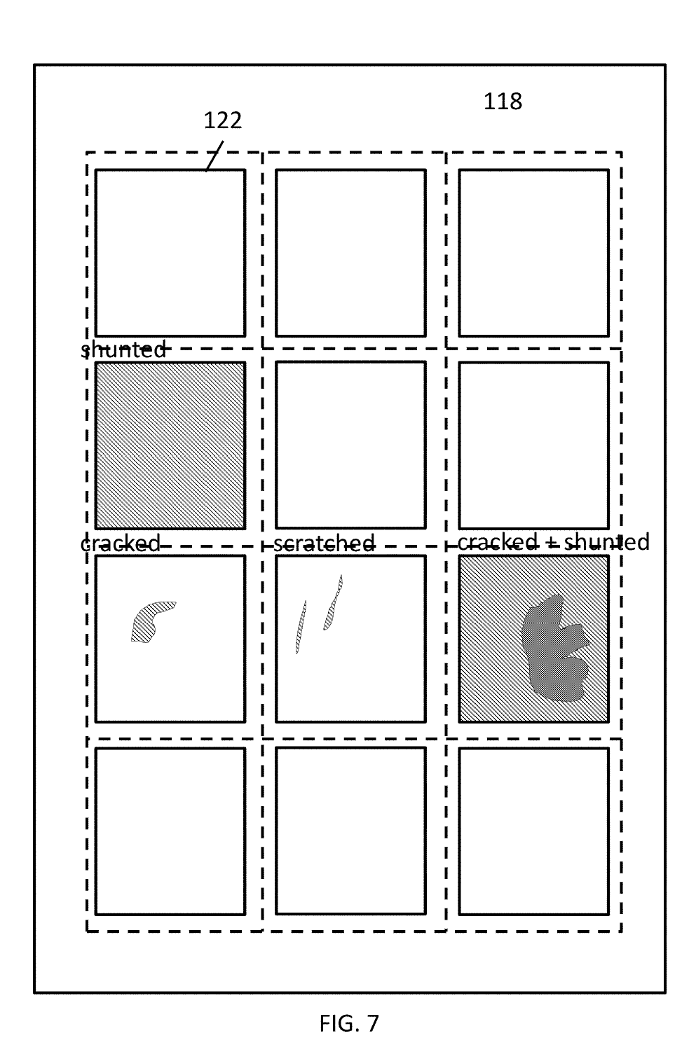

The image is then analyzed, and each solar cell 122 in the image is isolated from surrounding solar cells 122 (see FIG. 7) (704). In embodiments, edge detection methods such as Canny edge detection may be used to define an edge of a surface area of each of the solar cells 122. Thus, for each of the solar cells 122 in which electroluminescence is induced, the edge is identified as an area darker than the area of each solar cell 122. A target solar cell 122a is then identified in the image as a solar cell 122 which has not yet been evaluated (706). For purposes of clarity, reference will now be made to regions of the target solar cell 122a without repeated reference to the image of the target solar cell 122a. It will be appreciated that the pixels separated as associated with the target solar cell 122a have a corresponding relation to a portion of the surface of the target solar cell 122a.

For each target solar cell 122a cracks are detected by identifying regions of the target solar cell 122a which are darker than surrounding regions (708). More specifically, edge detection methods are executed to determine intensity boundaries which define regions along the surface of the target solar cell 122a (see FIG. 5). The intensity boundaries are identified by grouping or merging contiguous regions located along the target solar cell 122a by intensity value, thereby defining intensity regions within the image which correspond to areas on the target solar cell 122a. More generally, this method of grouping regions is commonly referred to in the art as “region merging” or “segmentation using region merging with edges.” For a detailed explanation of identifying regions in an image, reference may be made to Michael Gay, Segmentation Using Region Merging with Edges, in Alvey Vision Converence 115-119 (1989), the entire contents of which are incorporated by reference herein.

After identifying intensity regions “I_{region}” along the surface of target solar cell 122a, the value of each intensity region “I_{region”} located in the image are averaged to determine an average intensity value “avg(I_{region})” for each intensity region “I_{region}”. When the average intensity value “avg(I_{region})” of the intensity region “I_{region}” of the target solar cell 122a is less than or equal to an intensity threshold “I_{threshold}”, the region is identified as a dark region “R_{dark}” or crack (see FIG. 5).

When it is determined that the target solar cell 122a has one or more intensity regions “I_{region}” identified as dark regions “R_{dark}” which have a cumulative area greater than the area of a predetermined low intensity threshold region, the target solar cell 122a is identified as being short circuited or shunted (710). Based on the determination that the target solar cell 122a is shunted, the target solar cell 122a is marked as being defective (712). Alternatively, if the target solar cell 122a has one or more dark regions “R_{dark}” but is not identified as shunted (see FIG. 5) (714), the target solar cell 122a is identified as operationally defective (718). An operationally defective solar cell 122 is a solar cell 122 which may operate for any period of time, including through the expected life of the solar cell 122, but has defects such as dark regions “R_{dark}” or cracks which indicate a higher chance of failure relative to a solar cell 122 with fewer or no cracks.

Target solar cells 122a which are not identified as having failed are identified as being operational or passing (716). If there are unexamined solar cells 122 located on the solar panel 118, the method of detecting defective solar cells 122 reiterates until all the solar cells 122 have been analyzed (720). If there are all the solar cells 122 in the solar panel 118 have been analyzed and the number of solar cells 122 that failed exceeds the acceptable cell failure rate (e.g., two of ten solar cells are identified as failing, greater than 10 percent of solar cells 122 failed on the solar panel 118, etc.) (722) the solar panel is identified as failed or defective (726). Alternatively, if it is determined that less solar cells 122 failed relative to an acceptable failure rate (722), the solar panel 118 is identified as passing (724).

While the present disclosure has been discussed with reference to the testing system 100 inducing electroluminescence in a plurality of solar cells 122 of a solar panel 118, it is contemplated that, in embodiments, the testing system 100 may induce electroluminescence in an individual or target solar cell 122a or subsets of the solar cells 122 of a solar panel 118. As electroluminescence is induced in the target solar cell 122a or subsets of the solar cells 122 an imaging device 106 may capture sensor data or images of the target solar cell 122a or subset of solar cells 122 as electroluminescence is induced in the target solar cell 122a or subset of solar cells 122. This imaging process may be repeated for subsets or all the solar cells 122 of the solar panel 118. The images may then be analyzed individually for defects, or may be combined into a constituent image to be analyzed for defects, in accordance with the principles described in the present disclosure. Further, in embodiments, an electric power supply 114 may be configured to couple to a target solar cell 122a to induce electroluminescence in the target solar cell 122a. It will be understood that various modifications may be made to the embodiments of the presently disclosed solar panel testing system 100. Therefore, the above description should not be construed as limiting, but merely as exemplifications of embodiments. Those skilled in the art will envision other modifications within the scope and spirit of the present disclosure.

What is claimed is:

1. A system for testing a solar panel including a plurality of cells, the system comprising:
an electrical power supply configured to couple to a solar panel and supply an electrical current to at least one cell of the solar panel thereby inducing electroluminescence in the at least one cell;
an imaging device configured to measure the electroluminescence of the at least one cell; and
a computing device coupled to the imaging device, the computing device configured to determine a defect in the at least one cell based on a measurement of the electroluminescence of the at least one cell.

2. The system according to claim 1, wherein the electrical power supply is further configured to supply the electrical current at a first current level and at a second current level different from the first current level.

3. The system according to claim 2, wherein the imaging device is further configured to measure a first intensity of the electroluminescence in the at least one cell at the first current level and a second intensity of the electroluminescence in the at least one cell at a second current level.

4. The system according to claim 3, wherein the computing device is further configured to calculate an intensity ratio between the first intensity and the second intensity.

5. The system according to claim 4, wherein the computing device is further configured to compare the intensity ratio to a ratio threshold to determine whether the at least one cell is defective.

6. The system according to claim 1, wherein the imaging device is further configured to capture an image of the electroluminescence of the at least one cell.

7. The system according to claim 6, wherein the computing device is further configured to isolate each of the cells into a constituent image.

8. The system according to claim 7, wherein the computing device is further configured to analyze the constituent image to identify a physical defect in the at least one cell based on a difference in darkness of a portion of the constituent image.

9. The system according to claim 8, wherein the computing device is further configured to determine at least one of size or shape of the physical defect.

10. The system according to claim 9, wherein the computing device is further configured to determine at least one of a size or a shape of the physical defect by generating two lines contacting an image of the physical defect and measuring an angle formed by the two lines.

11. A method for testing a solar panel including at least one cell, the method comprising:
supplying an electrical current to at least one cell of the solar panel thereby inducing electroluminescence in the at least one cell;
measuring the electroluminescence of the at least one cell; and
determining a defect in the at least one cell based on the measurement of the electroluminescence of the cell.

12. The method of claim 11, wherein measuring the electroluminescence includes capturing an image of the solar panel.

13. The method of claim 12, wherein measuring the electroluminescence includes capturing an image of a plurality of cells of the solar panel.

14. The method of claim 13, further comprising isolating the cells of the solar panel in the image into a constituent image.

15. The method of claim 14, further comprising:
determining the electroluminescence of a plurality of regions of a target cell; and
determining at least one region includes the defect, wherein the target cell is one of the isolated cells.

16. The method of claim 15, wherein determining at least one region of the target cell includes the defect further includes determining the defect is a crack.

17. The method of claim 16, further comprising:
comparing an average electroluminescence of the target cell with an average electroluminescence of the isolated cells in response to determining the at least one region of the target cell includes the defect; and
determining the target cell is shunted based on comparison of the average electroluminescence of the target cell with the average electroluminescence of the isolated cells.

18. The method of claim 17, further comprising determining the target cell is non-operational based on determining the defect is a crack and the target cell is shunted.
